(19) United States
(12) Patent Application Publication
(10) Pub. No.: US 2025/0001373 A1
(43) Pub. Date: Jan. 2, 2025

(54) MIXING AND STIRRING APPARATUS, GYPSUM BOARD MANUFACTURING APPARATUS, AND GYPSUM BOARD MANUFACTURING METHOD

(71) Applicant: YOSHINO GYPSUM CO., LTD., Tokyo (JP)

(72) Inventors: Yuichi HIROOKA, Tokyo (JP); Kazumi ENDO, Tokyo (JP)

(21) Appl. No.: 18/690,857

(22) PCT Filed: Feb. 22, 2023
(86) PCT No.: PCT/JP2023/006511

§ 371 Date: Mar. 11, 2024

(30) Foreign Application Priority Data
Feb. 25, 2022 (JP) 2022-028259

(51) Int. Cl. B01F 29/86; B01F 23/50; B01F 35/32; B28B 1/14; B28B 13/02

(52) U.S. Cl. CPC B01F 29/86; B01F 23/565; B01F 35/3204; B01F 35/3213; B28B 1/14; B28B 2013/0265

(57) ABSTRACT

A mixing and stirring apparatus includes a mixer configured to prepare a gypsum slurry; and a mixer moving device, wherein the mixer includes a housing; a rotating plate arranged inside the housing; a rotary shaft connected to the rotating plate; a motor connected to the rotary shaft and configured to rotate the rotating plate; and a gypsum slurry extracting device configured to discharge the gypsum slurry prepared in the housing, wherein the mixer moving device is configured to move at least the housing, the rotating plate, the rotary shaft, and the gypsum slurry extracting device.

### TECHNICAL FIELD

The present invention relates to a mixing and stirring apparatus, a gypsum board manufacturing apparatus, and a gypsum board manufacturing method.

### BACKGROUND OF THE INVENTION

Patent Document 1 discloses a gypsum board manufacturing method having a step of sequentially supplying a lower base paper sheet, a gypsum slurry, and an upper base paper sheet on a belt conveyor and manufacturing a molded body having the gypsum slurry sandwiched between the lower base paper sheet and the upper base paper sheet, wherein a part of a boundary between the gypsum slurry and the base paper sheet, in an image of the gypsum slurry reservoir part where the gypsum slurry flows from a mixer to the center part in the width direction of the lower base paper sheet, is previously stored as an original image in an image analysis apparatus, and the position of an end part of the gypsum slurry reservoir part in the image of the gypsum slurry reservoir part captured by a camera in accordance with the position variation of the gypsum slurry, is measured by searching the position of an image approximate to the original image.

### RELATED ART DOCUMENTS

### Patent Document

Patent document 1: Japanese Unexamined Patent Application Publication No. H9-155829

### SUMMARY OF THE INVENTION

### Problems to be Solved by the Invention

As disclosed in Patent Document 1, in manufacturing a gypsum board, a gypsum slurry is prepared by mixing raw materials such as gypsum and water by a mixer, and the gypsum slurry is supplied on the surface of a board base paper sheet conveyed from the mixer. The board base paper sheet and the gypsum slurry are molded, dried, cut, etc., to manufacture a gypsum board of a desired shape and size.

In manufacturing a gypsum board, in order to uniformly supply the gypsum slurry on the board base paper sheet, the gypsum slurry is preferably supplied from a mixer to a conveyed board base paper sheet at a predetermined position, for example, at the center of the board base paper sheet in the width direction. However, there are cases where gypsum boards of different sizes, such as in width, are manufactured in the same manufacturing line. Further, the center of the board base paper sheet conveying path in the width direction does not always coincide with the center of the board base paper sheet in the width direction.

The mixer is fixed to a predetermined position on the manufacturing line, and, therefore, a gypsum slurry extraction device connected to the gypsum slurry discharge port of the mixer has been designed to be located in the center of the board base paper sheet conveying path in the width direction when manufacturing a product having a product width of the largest manufacturing ratio. The gypsum slurry extraction device means a non-deformable chute mainly made of metal, such as a vertical chute or a horizontal chute, for example. The vertical chute means a chute for vertically extracting the gypsum slurry from a mixer housing. The horizontal chute means a chute for horizontally extracting the gypsum slurry from a mixer housing.

For this reason, when manufacturing products having other product widths, the gypsum slurry has been supplied to the center in the width direction of the conveyed board base paper sheet by changing the position and orientation of the discharge port of a boot chute or a hose for supplying the gypsum slurry from the mixer to the board base paper sheet. The boot chute and the hose are connected to the above gypsum slurry extraction device and are mainly made of deformable materials such as rubber, vinyl chloride, silicon rubber, or the like.

However, it is difficult to properly adjust the position and orientation of the discharge port of the hose for supplying the gypsum slurry to the center in the width direction of the board base paper sheet that is being conveyed, and there has been a problem that it has been time consuming when switching the type of gypsum board to be manufactured, etc. Further, when changing the orientation of the discharge port of the hose for supplying the gypsum slurry from the mixer, there has been a problem that the supplying direction of the gypsum slurry does not coincide with the conveying direction of the board base paper sheet, and a force is applied to the board base paper sheet in a direction different from the conveying direction. Further, the position of the slurry discharge can be easily adjusted by lengthening and bending the boot chute and the hose, but a part of the gypsum slurry may be retained inside the boot chute or the like if there are many bent parts. Then, the retained gypsum slurry hardens and adheres to the boot chute and the hose, and the adhered matter grows to generate gypsum foreign matter. The generated gypsum foreign matter causes the manufacturing line to stop, due to cutting the board base paper sheet, etc.

In view of the above problems of the conventional technology, an object of an aspect of the present invention is to provide a mixing and stirring apparatus capable of easily changing the supplying position of a gypsum slurry.

### Means for Solving the Problem

In order to solve the above problem, according to an embodiment of the present invention, there is provided a mixing and stirring apparatus including a mixer configured to prepare a gypsum slurry; and a mixer moving device, wherein the mixer includes a housing; a rotating plate arranged inside the housing; a rotary shaft connected to the rotating plate; a motor connected to the rotary shaft and configured to rotate the rotating plate; and a gypsum slurry extracting device configured to discharge the gypsum slurry prepared in the housing, wherein the mixer moving device is configured to move at least the housing, the rotating plate, the rotary shaft, and the gypsum slurry extracting device.

### Effects of the Invention

According to an embodiment of the present invention, it is possible to provide a mixing and stirring apparatus capable of easily changing the supplying position of a gypsum slurry.

### BRIEF DESCRIPTION OF THE DRAWINGS

FIG. 1 is an explanatory view of a mixing and stirring apparatus according to an embodiment of the present invention.

FIG. 2 is a perspective view of the peripheral portion of the housing of the mixer.

FIG. 3 is an explanatory view of the internal structure of the housing of the mixer.

FIG. 4 is an explanatory view of a gypsum board manufacturing apparatus.

FIG. 5 is an explanatory view of a gypsum board manufacturing apparatus.

### DETAILED DESCRIPTION OF THE INVENTION

Although the embodiment for carrying out the present invention will be described below with reference to the drawings, the present invention is not limited to the following embodiments, and various variations and substitutions can be made to the following embodiments without departing from the scope of the invention.

### [Mixing and Stirring Apparatus]

The mixing and stirring apparatus of the present embodiment will be described below.

The inventor of the present invention performed studies to obtain a mixing and stirring apparatus in which the supplying position of gypsum slurry can be easily changed. As a result, it was found that the supplying position of the gypsum slurry can be easily changed by making at least a part of the mixer for preparing the gypsum slurry movable, whereas the mixer has conventionally been fixed and used, and the present invention was completed.

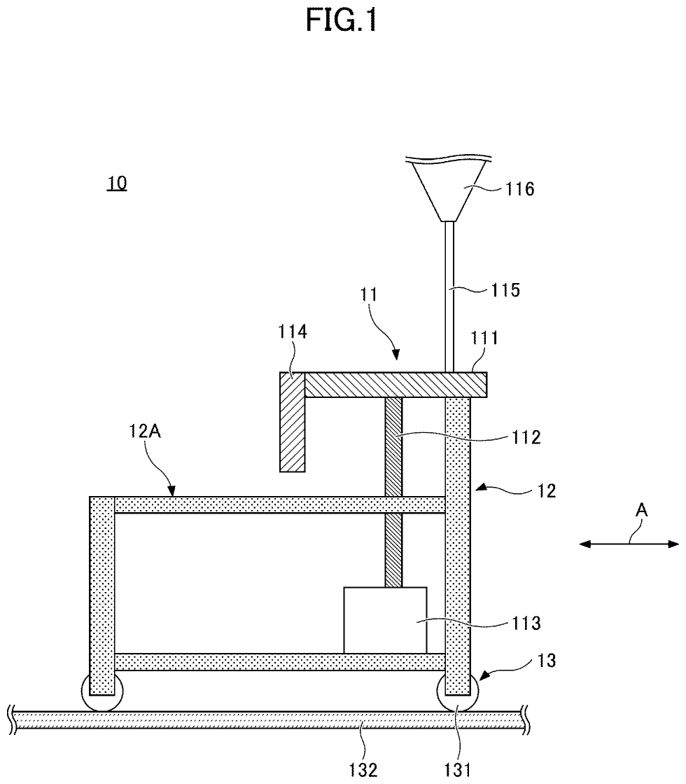

Therefore, as illustrated in FIG. 1, a mixing and stirring apparatus 10 of the present embodiment can include a mixer 11 for preparing the gypsum slurry and a mixer moving device 13. FIG. 1 schematically illustrates a side view of the mixing and stirring apparatus 10 of the present embodiment.

The position of a gypsum slurry extracting device 114 for discharging the gypsum slurry, which is provided in the mixer 11, can be easily adjusted by making at least a part of the mixer 11 movable by the mixer moving device 13, the at least the part having been used in a fixed position conventionally. Therefore, the mixing and stirring apparatus 10 can easily change the supplying position of the gypsum slurry.

Hereinafter, each member of the mixing and stirring apparatus of the present embodiment will be described.

### (1) Mixer

### (Housing)

The mixer 11 may be configured to mix gypsum, water, and various additives used as a raw material for gypsum slurry, and may have a housing 111, for example, although not limited thereto.

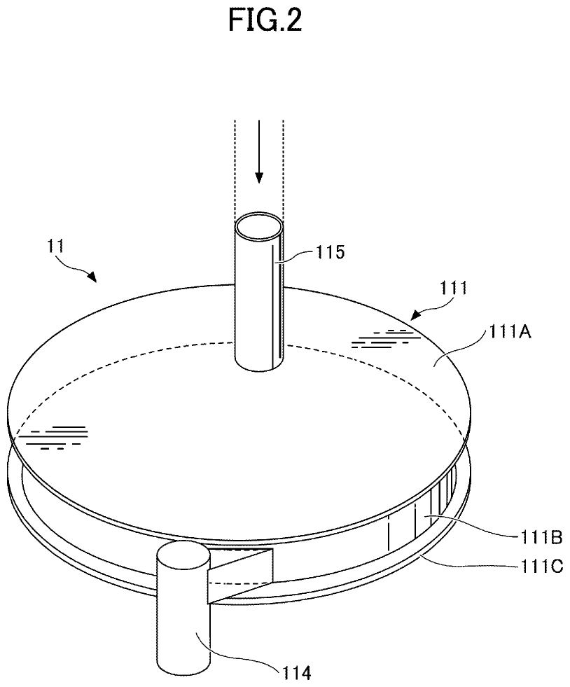

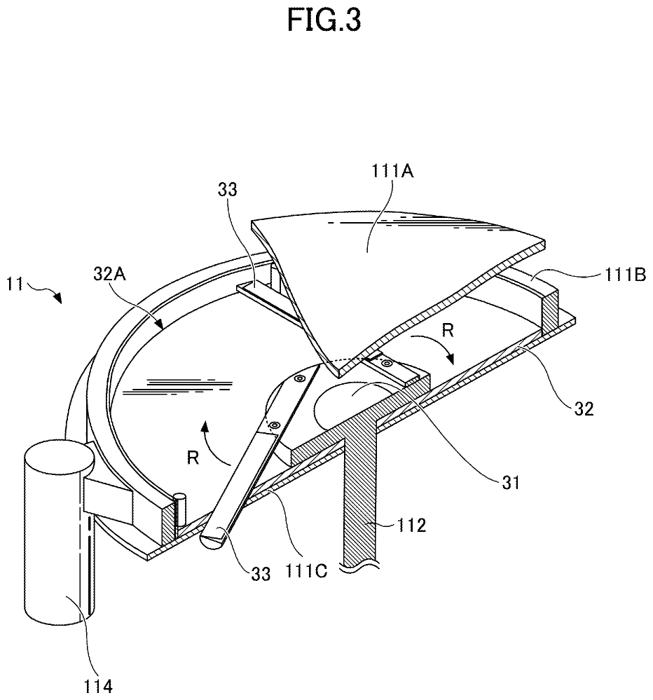

The housing 111 of the mixer 11 and the configuration within the housing 111 are illustrated in FIGS. 2 and 3. FIG. 2 is a perspective view of the periphery of the housing 111 of the mixer 11, and FIG. 3 is a partially broken perspective view illustrating the internal structure of the housing 111 of the mixer 11.

As illustrated in FIGS. 2 and 3, the housing 111 may have an upper plate 111A, a lower plate 111C arranged to face the upper plate 111A, and a side plate 111B arranged between the upper plate 111A and the lower plate 111C. The housing 111 has a mixing and stirring region inside, surrounded by the upper plate 111A, the lower plate 111C, and the side plate 111B for mixing and stirring supplied raw materials such as calcined gypsum, water, and additives. That is, the mixing and stirring region is a region inside the housing 111 surrounded by the upper plate 111A, the lower plate 111C, and the side plate 111B for mixing gypsum, water, and various additives used as raw materials for gypsum slurry.

The housing 111 may have a flat cylindrical shape. Therefore, the upper plate 111A and the lower plate 111C may have a plate-like shape and, for example, a circular shape as illustrated in FIG. 2. Further, the side plate 111B may have a circular shape when viewed from vertically above the upper surface of the upper plate 111A.

In between the upper plate 111A and the lower plate 111C, the side plate 111B is arranged, and, therefore, the upper plate 111A and the lower plate 111C are arranged at a predetermined interval in the height direction. Therefore, as described above, a mixing and stirring region for mixing the supplied raw materials is formed in the housing 111.

In order to prevent an excessive increase in the internal pressure in the mixer 11, for example, in the mixing and stirring region, an internal pressure adjusting means (not illustrated) or the like may be provided in any part of the housing 111, such as on the upper plate 111A.

### (Rotating Plate)

The mixer 11 may have a rotating plate 32 having a disk shape (see FIG. 3). The rotating plate 32 can be arranged in the housing 111 as illustrated in FIG. 3. The rotating plate 32 is arranged rotatably, and in the mixer 11, by rotating the rotating plate 32 in the direction of the arrow R, for example, the raw material supplied in the mixing and stirring region can be caused to flow in the circumferential direction in the outer peripheral region by centrifugal force effects, and mixed and stirred.

The rotating plate 32 performs the mixing and stirring by applying a centrifugal force to the raw material supplied to the upper surface of the rotating plate as described above, and, therefore, the upper surface of the rotating plate 32 and the lower surface of the upper plate 111A can be separated and arranged to have a fixed interval.

Although the size of the rotating plate 32 is not particularly limited, it is preferable to select the size such that the diameter of the rotating plate 32 and the diameter of the inner periphery of the side plate 111B substantially coincide, so that the raw material supplied to the inside of the housing 111 can be uniformly mixed. However, when the rotating plate 32 is rotated, a clearance may be provided between the rotating plate 32 and the side plate 111B, so that the rotating plate 32 does not come into contact with the inner peripheral surface of the side plate 111B.

In FIG. 3, as the rotating plate 32, a plate having a circular shape with a smooth outer periphery 32A is illustrated, but the rotating plate 32 is not limited to this configuration. The rotating plate 32 may have a large number of tooth-shaped portions along the outer periphery 32A thereof. By providing the tooth-shaped portions in this manner, the supplied raw material can be uniformly mixed.

The tooth-shaped portions can be formed by providing notches on the outer periphery 32A, that is, by providing irregularities on the outer periphery 32A.

On the upper surface of the rotating plate 32, a plurality of pins or the like can be arranged perpendicularly to the upper surface so that the supplied raw materials are mixed more uniformly. When a plurality of pins are arranged on the upper surface of the rotating plate 32, the pins can be arranged at a fixed interval along the outer periphery of the rotating plate 32 or along the diameter direction of the rotating plate 32. The above-mentioned tooth-shaped portions can be provided on the rotating plate 32, and the pins can also be arranged.

The mixer 11 can also have a scraper 33.

Specifically, as illustrated in FIG. 3, for example, the scraper 33 having a rod-like shape may further be arranged above the upper surface of the rotating plate 32 and inside the mixing and stirring region.

Specifically, the scraper 33 may be arranged, for example, on the upper surface of an annular base 31 connected to a rotary shaft 112, which will be described later. The scraper 33 may then be configured to rotate through the annular base 31 with the rotation of the rotary shaft 112.

By providing the scraper 33, calcined gypsum or the like attached to the lower surface of the upper plate 111A and the inner peripheral surface of the side plate 111B can be removed. Further, the supplied calcined gypsum, water, additives and the like can be mixed particularly uniformly. In order to prevent abrasion, the scraper 33 may have a configuration in which a sprayed film is arranged on a part of or on the entirety of the surface thereof, or may have a configuration in which a ceramic plate is attached, according to need.

### (Rotary Shaft)

The rotating plate 32 is rotatably arranged in the housing 111 as described above, and to rotate the rotating plate 32, the mixer 11 may have a rotary shaft 112 connected to the rotating plate 32.

The rotary shaft 112 may be connected to the rotating plate 32, the arrangement of which is not particularly limited, but may be inserted into the housing 111 from above or below the housing 111, for example, and connected to the upper or lower surface of the rotating plate 32.

In particular, the rotary shaft 112 is preferably inserted into the housing 111 from below the housing 111 and connected to the rotating plate 32.

With the above-mentioned arrangement of the rotary shaft 112, equipment such as a motor connected to the rotary shaft 112 can also be arranged below the housing 111. Therefore, the degree of freedom of the layout above the housing 111 can be increased.

The rotary shaft 112 can be connected to the lower surface of the rotating plate 32 as described above, or the rotary shaft 112 can be connected to the upper surface of the rotating plate 32 through the annular base 31 or the like by providing a through hole in the rotating plate 32.

### (Motor)

The mixer 11 may further have a motor 113 connected to the rotary shaft 112 and configured to rotate the rotating plate 32 through the rotary shaft 112. A speed changer or the like may be provided between the rotary shaft 112 and the motor 113 according to need.

The motor 113 may be configured to rotate the rotary shaft 112 about the central axis thereof, that is, to rotate the rotary shaft 112 with its central axis at the center of rotation, and the motor 113 is preferably arranged below the housing 111, although the arrangement is not particularly limited. The motor 113 preferably supports the mixer 11 as illustrated in FIG. 1, for example, and is supported by a cradle 12 connected to the mixer moving device 13. That is, it is preferable that the mixer moving device 13 is configured so that the motor 113 can also be moved. With the above configuration, the motor 113 can also be moved when the housing 111 or the like of the mixer 11 is moved, and the position of the mixer 11 can be easily displaced.

### (Gypsum Slurry Extracting Device)

The mixer 11 may have the gypsum slurry extracting device 114 for discharging the gypsum slurry prepared in the housing 111 to the outside of the housing 111 by mixing and stirring raw materials such as calcined gypsum in a mixing and stirring region in the housing 111. The gypsum slurry extracting device 114 may be provided on the side plate 111B and the lower plate 111C of the housing 111, and may be a pipe-shaped chute such as a cylindrical chute. The gypsum slurry extracting device 114 can be a vertical chute or a horizontal chute, and can be arranged so as to be connected to an opening provided in the side plate 111B or the lower plate 111C as described above. The vertical chute means a chute for vertically extracting the gypsum slurry from the mixer housing. The horizontal chute means a chute for horizontally extracting the gypsum slurry from the mixer housing.

Thus, the gypsum slurry extracting device 114 may include a pipeline for conveying the gypsum slurry that connects the cylindrical chute with an opening provided in the housing 111, according to need. The gypsum slurry extracting device 114 is preferably a non-deformable chute made of, for example, metal. A boot chute, a hose or the like may be connected to the gypsum slurry extracting device 114, according to need.

In FIG. 1 and the like, an example in which one gypsum slurry extracting device 114 is provided in the housing 111 is illustrated, but the embodiment is not limited thereto, and the mixer 11 may have a plurality of discharge ports, and a gypsum slurry extracting device or the like connected to the discharge ports.

### (Raw Material Supply Pipe)

The upper plate 111A of the housing 111 may be provided with a raw material supply port for supplying raw materials such as calcined gypsum to a mixing and stirring region in the housing 111. For example, a through hole may be formed in the upper plate 111A to provide a raw material supply port.

As illustrated in FIGS. 1 and 2, a raw material supply pipe 115 and a raw material hopper 116 are connected to the raw material supply port, and the raw material can be supplied into the mixing and stirring region through the raw material hopper 116, the raw material supply pipe 115, and the raw material supply port.

Although an example of one raw material supply pipe 115 is illustrated in FIG. 1 and the like, the embodiment is not limited thereto, and a plurality of raw material supply pipes can be provided depending on the type and the number of raw materials to be supplied.

### (2) Mixer Moving Device

The mixing and stirring apparatus 10 of the present embodiment may include the mixer moving device 13. As illustrated in FIG. 1, the mixer moving device 13 may be configured to move at least a portion of the mixer 11, specifically the housing 111, the rotating plate 32, the rotary shaft 112, and the gypsum slurry extracting device 114.

FIG. 1 illustrates an example of the mixer moving device 13 having a wheel 131 and a guide 132 such as a rail so as to be movable along the double-headed arrow A, but the embodiment is not limited thereto. The mixer moving device 13 may be a device capable of moving the mixer 11 in any of one or two or more directions, and the configuration thereof is not particularly limited.

The mixer moving device 13 may have wheels, sliders, or the like. The mixer moving device 13 may also have the guide 132, such as a rail, that regulates the moving direction of a rotating member, such as a wheel, according to need.

Conventionally, the mixer is fixed to the vicinity of a gypsum board manufacturing line to be used. On the other hand, the mixing and stirring apparatus 10 of the present embodiment is provided with a mixer moving device 13, and the position of the housing 111 of the mixer 11 and the gypsum slurry extracting device 114 can be changed. Therefore, the position of the gypsum slurry extracting device 114 or the like can be changed according to the position of the conveyed board base paper sheet, and the prepared gypsum slurry can be supplied to an optimum position from the gypsum slurry extracting device 114. Furthermore, not only can the position and width of the board base paper sheet be changed, but the gypsum slurry can be manufactured by using the gypsum slurry extracting device 114 having various shapes. Further, even when a failure such as a breakdown occurs in the mixer 11 of the mixing and stirring apparatus 10, the housing 111 of the mixer 11 or the like is carried out by the mixer moving device 13 and replaced with another spare device, so that the time of stopping the manufacturing line can be reduced and the manufacturing of the gypsum board can be continued.

The mixer moving device 13 may be configured to move at least the gypsum slurry extracting device 114 for discharging the gypsum slurry, the housing 111 connected thereto, the rotating plate 32 included in the housing 111, and the rotary shaft 112, in the mixer 11. However, it is preferable that the mixer moving device 13 is also configured to move the aforementioned motor 113, the raw material supply pipe 115, and the like together.

A control device (not illustrated) may be connected to the mixer moving device 13, so that the position of the discharge port of the gypsum slurry in the gypsum slurry extracting device 114 of the mixer 11 can be automatically adjusted to be at a predetermined position according to the position of the conveyed board base paper sheet. In this case, the mixing and stirring apparatus 10 may be provided with a detection device for detecting the position of the end portion of the board base paper sheet in the width direction and the position of the discharge port of the gypsum slurry in the gypsum slurry extracting device 114. The mixing and stirring apparatus 10 may also be provided with a driving device such as a motor used when the position of the housing 111 or the like is moved by the mixer moving device 13. The control device may be connected with the detection device and the driving device by wire or wirelessly so as to transmit and receive control signals, position information of the widthwise end of the board base paper sheet, and detection information such as the position information of the gypsum slurry discharge port.

For example, the optimum position of the gypsum slurry extracting device 114 or the like of the mixer 11 may be recorded for each type to be manufactured in advance, and the position of the gypsum slurry extracting device 114 or the like of the mixer 11 may be adjusted according to the type to be manufactured. In this case, the above position may be stored in a storage device, and the control device may be configured to adjust the position of the gypsum slurry extracting device 114 or the like of the mixer 11 according to the input type to be manufactured.

Further, the mixing and stirring apparatus 10 may have a stopper or a fixing means so that the position of the gypsum slurry extracting device 114 or the like of the mixer 11 does not change after the position of the gypsum slurry extracting device 114 or the like of the mixer 11 is adjusted. For the stopper or the fixing means, various methods may be used; for example, a driving device or the like with a brake may be used, or a method of pressing or clamping with a cylinder or the like, or the like, may be used.

### (3) Cradle

The mixing and stirring apparatus 10 of the present embodiment may include a cradle 12 according to need, which is a frame that supports the mixer 11 and that connects the mixer 11 and the mixer moving device 13.

Preferably, the cradle 12 is configured to also support additional equipment of the mixer 11, such as the aforementioned motor 113.

Further, it is preferable that the cradle 12 is configured to be capable of conveying the board base paper sheet on a surface 12A facing the lower plate 111C of the mixer 11. The surface 12A may be a flat surface and may have a roll or the like according to need.

With the surface 12A facing the lower plate 111C of the mixer 11, the board base paper sheet can be carried, so that the mixing and stirring apparatus 10 of the present embodiment can be inserted and arranged in a gypsum board manufacturing apparatus, and the board base paper sheet can be supplied to easily manufacture the gypsum board.

### [Gypsum Board Manufacturing Apparatus]

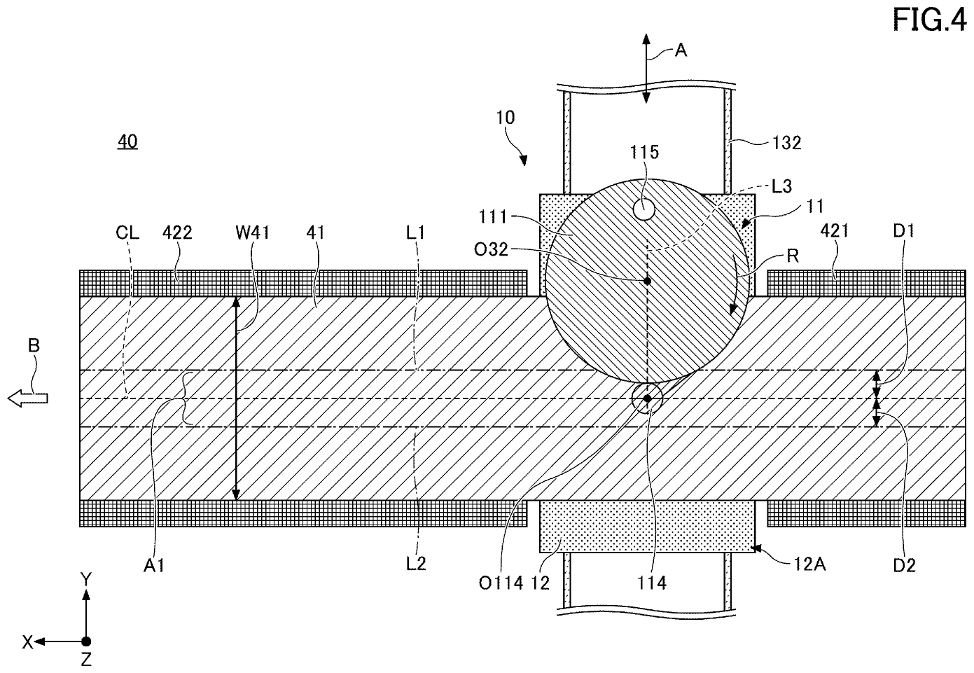

For example, as illustrated in FIG. 4, a gypsum board manufacturing apparatus 40 of the present embodiment may include the mixing and stirring apparatus 10 described above. The mixing and stirring apparatus 10 has already been described, and, therefore, the description will be omitted here. The mixing and stirring apparatus 10 is provided with the mixer moving device 13, and the position of a gypsum slurry extracting device 114 or the like in the mixer 11 can be changed. Therefore, according to the gypsum board manufacturing apparatus 40 of the present embodiment, the position of the gypsum slurry extracting device 114 or the like in the mixer 11 can be changed according to the position of the conveyed board base paper sheet 41, and the gypsum slurry can be supplied to an optimum position. Further, even if a failure such as a breakdown occurs in the mixer 11 in the mixing and stirring apparatus 10, the housing 111 or the like of the mixer 11 can be carried out by the mixer moving device 13 and replaced with another spare device, so that the time of stopping the manufacturing line can be reduced and the manufacturing of the gypsum board can be continued.

### (Board Base Paper Sheet Conveying Path)

The gypsum board manufacturing apparatus according to the present embodiment may have a board base paper sheet conveying path for conveying and supplying the board base paper sheet in addition to the mixing and stirring apparatus 10. For example, the gypsum board manufacturing apparatus 40 illustrated in FIG. 4 has a first board base paper sheet conveying path 421 on the upstream side of the mixing and stirring apparatus 10 and a second board base paper sheet conveying path 422 on the downstream side of the mixing and stirring apparatus 10 in the conveyance direction of the board base paper sheet 41. Between the first board base paper sheet conveying path 421 and the second board base paper sheet conveying path 422, a surface 12A which is a part of the cradle 12 of the mixing and stirring apparatus 10 serves as the base paper sheet conveying path.

In FIG. 4, the X-axis is in the direction parallel to the conveyance direction of the board base paper sheet 41, and the Y-axis is in the width direction of the board base paper sheet 41. The Z-axis is in the height direction. In FIG. 4, the board base paper sheet 41 is conveyed along the block arrow B from the right side to the left side in the figure.

The board base paper sheet conveying path may be configured to convey and supply the board base paper sheet below the gypsum slurry extracting device 114. Therefore, when viewed from above, i.e., along the Z axis of FIG. 4, the board base paper sheet conveying path can be arranged so that at least a portion thereof is located below the housing 111 of the mixer 11 or the gypsum slurry extracting device 114 of the mixer 11. The board base paper sheet conveying path may be arranged so that at least a portion thereof is located below both the housing 111 of the mixer 11 and the gypsum slurry extracting device 114 of the mixer 11. The board base paper sheet conveying path may include, for example, a support plate for supporting the board base paper sheet, and one or more kinds of conveying devices selected from various rolls, belt conveyors, roll conveyors, and the like. That is, the board base paper sheet conveying path may include, for example, one or more kinds of elements selected from a support plate and a conveying device. The support plate may be a plate that supports the board base paper sheet and does not inhibit the conveying of the board base paper sheet, and is not particularly limited. The support plate may be, for example, a flat plate. The material of the support plate is not particularly limited, and metal, for example, may be used.

In the gypsum board manufacturing apparatus 40, when viewed from above the gypsum slurry extracting device 114 and the board base paper sheet 41, a center O114 of the gypsum slurry extracting device 114 is preferably located in the center region A1 including the center in the width direction of the board base paper sheet 41 conveyed onto the board base paper sheet conveying path. When the center O114 of the gypsum slurry extracting device 114 is located in the center region A1 including the center in the width direction of the board base paper sheet 41, when viewed from above the gypsum slurry extracting device 114 and the board base paper sheet 41, the center O114 of the gypsum slurry extracting device 114 is located in the center region A1 sandwiched between the straight line L1 and the straight line L2. The distance D1 between the line L1 and the center line CL and the distance D2 between the line L2 and the center line CL are preferably 15% and more preferably 10% of the width W41 of the board base paper sheet 41. The center of the board base paper sheet 41 in the width direction is a point on the center line CL in FIG. 4.

The gypsum slurry extracting device 114 has a cylindrical shape, for example. Therefore, the center O114 of the gypsum slurry extracting device 114 means the center of the circumscribed circle or the minimum inclusion circle of the outer shape of the cylindrical part of the gypsum slurry extracting device 114 when viewed from above the gypsum slurry extracting device 114, that is, viewed along the Z-axis in FIG. 4.

The center O114 of the gypsum slurry extracting device 114 is located in the center region A1 including the center in the width direction of the board base paper sheet 41 conveyed on the board base paper sheet conveying path, and, therefore, the gypsum slurry can be uniformly supplied to the surface of the board base paper sheet 41.

In particular, it is preferable that the center O114 of the gypsum slurry extracting device 114 coincides with the center line CL at the center in the width direction of the board base paper sheet 41 when viewed from above the gypsum slurry extracting device 114 and the board base paper sheet 41.

Preferably, the rotation center O32 of the rotating plate 32 and the center O114 of the gypsum slurry extracting device 114 are arranged on a straight line parallel to the width direction of the board base paper sheet 41 conveyed on the board base paper sheet conveying path. That is, the straight line L3 connecting the rotation center O32 of the rotating plate 32 and the center O114 of the gypsum slurry extracting device 114 is preferably arranged in the width direction of the board base paper sheet 41, that is, along the Y-axis of FIG. 4. Note that the term parallel here does not mean geometrically exact, but means that the straight line L3 connecting the rotation center O32 of the rotating plate 32 and the center O114 of the gypsum slurry extracting device 114 and the width direction of the board base paper sheet 41 are arranged in parallel. For example, if the angle formed by the width direction of the board base paper sheet 41 and the straight line L3 is within 5°, it can be assumed that these are parallel.

When preparing the gypsum slurry in the mixer 11, the rotating plate 32 rotates along the arrow R in the figure (see FIG. 3), and a force is applied to the gypsum slurry along the tangential direction of the outer periphery 32A of the rotating plate 32. Therefore, with the above arrangement, the direction of the force applied to the gypsum slurry discharged from the gypsum slurry extracting device 114 coincides with the conveying direction of the board base paper sheet 41. Therefore, by the gypsum slurry supplied on the board base paper sheet 41, the force applied to the board base paper sheet 41 in a direction different from the conveying direction can be reduced, and the gypsum slurry can be uniformly spread on the board base paper sheet 41.

### (Other Members)

The gypsum board manufacturing apparatus according to the present embodiment may also have members other than the mixer and the board base paper sheet conveying path.

The gypsum board manufacturing apparatus according to the present embodiment may include, for example, a molding device for molding a board base paper sheet and the gypsum slurry supplied on the board base paper sheet into a predetermined shape. The gypsum board manufacturing apparatus may also include a drying device for drying moisture in the gypsum slurry, a cutting device for molding the board base paper sheet and the gypsum slurry and cutting the hardened material, and a carrying out device for carrying out the manufactured gypsum board.

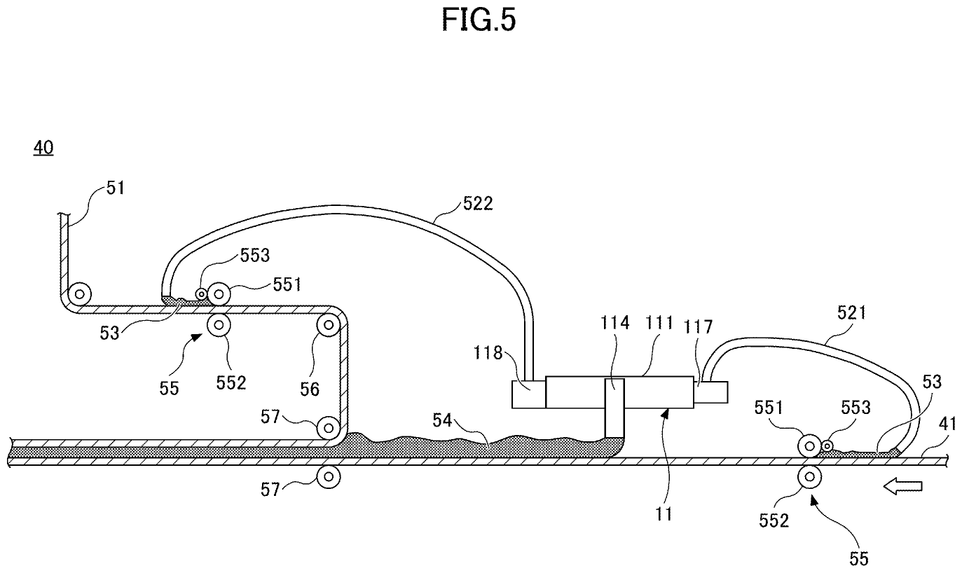

FIG. 5 illustrates a configuration example of the gypsum board manufacturing apparatus 40 according to the present embodiment illustrating portions other than that around the mixing and stirring apparatus. FIG. 5 illustrates only the mixer 11 of the mixing and stirring apparatus 10.

From the right side to the left side in FIG. 5, the board base paper sheet 41 as a surface material is conveyed along the manufacturing line. The board base paper sheet 41 is sometimes referred to as the front cover base paper sheet, and a board base paper sheet 51, which will be described later, is sometimes referred to as the back cover base paper sheet.

In the mixer 11, calcined gypsum as a raw material of a gypsum slurry, water and, in some cases, various additives are kneaded to manufacture a gypsum slurry.

If necessary, foam can be added from the gypsum slurry extracting device 114 or gypsum slurry dispensing ports 117 and 118 provided in the housing 111, and the amount of foam added can be adjusted to manufacture a gypsum slurry of any density. The gypsum slurry extraction device may be arranged in the dispensing ports 117 and 118. For example, by adjusting the amount of foam added, a first gypsum slurry 53 and a second gypsum slurry 54 having different densities can be prepared. The foam can also be supplied to the mixer 11 together with other raw materials of the gypsum slurry, instead of from the dispensing port.

The obtained first gypsum slurry 53 is then supplied to the board base paper sheet 41 and the board base paper sheet 51 on the upstream side of a roll coater 55 through delivery pipes 521 and 522. The upstream side means the upstream side in the conveying direction of the board base paper sheets 41 and 51. The first gypsum slurry 53 on the board base paper sheets 41 and 51 reaches the extending portion of the roll coater 55 and extends at the extending portion. The roll coater 55 has a coating roll 551, a receiving roll 552, and a foreign matter removing roll 553, and the first gypsum slurry 53 is extended by these rolls.

A thin layer of the first gypsum slurry 53 is formed on board base paper sheets 41 and 51. FIG. 5 illustrates an example in which the first gypsum slurry 53 is applied to board base paper sheets 41 and 51 by using the roll coater 55, but the embodiment is not limited thereto. For example, the first gypsum slurry 53 may be applied to only one of board base paper sheets 41 and 51 by using the roll coater 55. Also, the first gypsum slurry 53 may be arranged only at the side end of the board base paper sheet 41.

The board base paper sheet 41, which is the front cover base paper sheet, is conveyed as it is, and the board base paper sheet 51, which is the back cover base paper sheet, is turned in the conveying line direction of the board base paper sheet 41 by the turning roll 56. Both the board base paper sheets 41 and 51 reach a molding device 57. Here, between the thin layers formed on the board base paper sheets 41 and 51, the second gypsum slurry 54 is supplied from the mixer 11 through the gypsum slurry extracting device 114. Therefore, a continuous laminate formed by laminating a layer formed by the first gypsum slurry 53, a layer formed by the second gypsum slurry 54, and a layer formed by the first gypsum slurry 53 can be formed between the board base paper sheets 41 and 51.

The embodiment is not limited to using the first gypsum slurry and the second gypsum slurry, but in the embodiment, for example, a gypsum slurry of one kind of density may be manufactured and supplied to the board base paper sheet.

Specifically, for example, a gypsum slurry of a predetermined density is fed to and deposited on the board base paper sheet continuously being conveyed. Then, the board base paper sheet 41 is folded along the engraved lines respectively applied to both end edges so as to entrap the gypsum slurry. At this time, the board base paper sheet 51 conveyed at the same speed is placed on the layer of the gypsum slurry. Then, a gypsum board is molded by passing through the molding device 57 for determining the thickness and width of the gypsum board. The gypsum board can also be molded by the above procedure.

On the downstream side of the molding device 57, the aforementioned drying device, the cutting device, the carrying out device, and the like may be arranged according to need.

Although the case of manufacturing a gypsum board has been described here by way of example, the embodiment is not limited thereto. For example, it is possible to manufacture various gypsum type building materials by changing the board base paper sheet that is a surface material to glass fiber nonwoven fabric (glass tissue) or a glass mat, and arranging this material to be embedded on or near the surface.

### [Method for Manufacturing Gypsum Board]

The method for manufacturing a gypsum board according to the present embodiment may include a slurry preparation step and a supplying step. The slurry preparation step is a step for preparing a gypsum slurry by a mixer provided in the mixing and stirring apparatus described above. The supplying step is a step for supplying a gypsum slurry from the gypsum slurry extraction device provided in the mixer onto the board base paper sheet being conveyed.

### (Slurry Preparation Step)

In the slurry preparation step, raw materials containing calcined gypsum and water can be kneaded by using a mixer provided in the mixing and stirring apparatus described above.

The calcined gypsum contained in the raw material is also referred to as a calcium sulfate ½ hydrate and is an inorganic composition having hydraulic properties. In the manufacturing method of the gypsum board according to the present embodiment, one of or a mixture of both of a type and β type calcined gypsum obtained by calcination of one or more types of gypsum selected from natural gypsum, by-product gypsum, flue gas desulfurization gypsum, etc., in air or water (including steam), can be used as the calcined gypsum. Further, the calcined gypsum used in the manufacturing method of the gypsum board according to the present embodiment may contain a small amount of type III gypsum anhydrite formed when the calcined gypsum is obtained.

In the case of the α type calcined gypsum, gypsum dihydrate such as natural gypsum needs to be pressure calcined in water or steam by using an autoclave. Further, the β type calcined gypsum can be manufactured by atmospheric ordinary pressure calcination of gypsum dihydrate such as natural gypsum.

Next, water added in preparing a gypsum slurry will be described.

Water can be added to the gypsum slurry for kneading calcined gypsum or the like. The amount of water added in forming the gypsum slurry is not particularly limited and can be any amount depending on the required fluidity.

The raw material of the gypsum slurry can contain any component other than the aforementioned calcined gypsum and water.

For example, foam can be added to form the gypsum slurry. The specific gravity of the gypsum board obtained by adjusting the amount of foam added can be set to a desired range.

The method of adding foam in forming the gypsum slurry is not particularly limited and can be added by any method. For example, a foaming agent (frothing agent) is added to water (water for forming foam) in advance, and foam is formed by stirring the foaming agent while taking in air, and the formed foam is mixed together with the calcined gypsum or water (kneading water of gypsum slurry) to form a gypsum slurry with added foam. Alternatively, the formed foam can be added to the gypsum slurry formed by mixing the calcined gypsum with water or the like in advance, to form the gypsum slurry to which the foam is added.

Examples of foaming agents used in forming the foam include, but are not particularly limited to, alkyl sulfate soda, alkyl ether sulfate, alkyl benzene sulfonic acid soda, polyoxyethylene alkyl sulfate, and the like.

The amount of foam added is not particularly limited and can be arbitrarily selected according to the specific gravity required for the gypsum board (gypsum-containing board) to be prepared.

Further, the raw material can also contain various additives that are conventionally added to the raw material of the gypsum board, such as adhesiveness improvers such as starch and polyvinyl alcohol, which improve the adhesion between the surface material such as the board base paper sheet and the gypsum core, inorganic fibers such as glass fibers and lightweight aggregates, refractory materials such as vermiculite, condensation modifiers, water reducers, foam diameter modifiers such as sulfosuccinate-type surfactants, and water repellents such as silicone and paraffin.

When the raw material is kneaded and the gypsum slurry is prepared, all components constituting the raw material may be kneaded simultaneously, but the kneading can be carried out in plural parts. For example, a solid component of the raw material may be mixed and kneaded to form a gypsum composition, and then a liquid component such as water of the raw material may be added to the obtained gypsum composition and further kneaded in a mixer to form a gypsum slurry.

### (Supply Process)

In the supply process, the gypsum slurry can be supplied from the gypsum slurry extracting device 114 of the mixer 11 onto the board base paper sheet supplied and conveyed.

The manufacturing method of the gypsum board according to the present embodiment may further include an optional step other than the slurry preparation step and the supply step.

### (Adjustment Step)

The gypsum board manufacturing method of the present embodiment may have an adjustment step for adjusting the position of the gypsum slurry extracting device 114 of the mixer 11 provided in the mixing and stirring apparatus 10 in accordance with the position of the board base paper sheet.

The mixing and stirring apparatus 10 used in the gypsum board manufacturing method of the present embodiment has the mixer moving device 13 as described above, and the position of the gypsum slurry extracting device 114 of the mixer 11 can be adjusted. Therefore, in the adjustment step, the position of the gypsum slurry extracting device 114 can be adjusted so as to be a predetermined position according to the position of the conveyed board base paper sheet.

The adjustment content of the position of the gypsum slurry extracting device 114 in the adjustment process is not particularly limited. As described above, when viewed from above the gypsum slurry extracting device 114 and the board base paper sheet 41, the center O114 of the gypsum slurry extracting device 114 is preferably located in the center region A1 including the center in the width direction of the board base paper sheet 41 conveyed on the board base paper sheet conveying path (see FIG. 4). The center region A1 has already been described, and, therefore, the description will be omitted here. Therefore, in the adjustment process, it is preferable to adjust the position of the gypsum slurry extracting device 114 so that the center O114 of the gypsum slurry extracting device 114 of the mixer 11 is located in the center region A1 in the width direction of the board base paper sheet 41 conveyed on the board base paper sheet conveying path.

The center O114 of the gypsum slurry extracting device 114 is located in the center region A1 in the width direction of the board base paper sheet 41 conveyed on the board base paper sheet conveying path, and, therefore, the gypsum slurry can be uniformly supplied to the surface of the board base paper sheet 41.

In particular, it is preferable that the center O114 of the gypsum slurry extracting device 114 coincides with the center line CL that is at the center in the width direction of the board base paper sheet 41 when viewed from above the board base paper sheet 41.

Further, it is preferable that the rotation center O32 of the rotating plate 32 and the center O114 of the gypsum slurry extracting device 114 are arranged on a straight line parallel to the width direction of the board base paper sheet 41 supplied and conveyed on the board base paper sheet conveying path. That is, a straight line L3 connecting the rotation center O32 of the rotating plate 32 and the center O114 of the gypsum slurry extracting device 114 is preferably arranged along the width direction of the board base paper sheet 41, that is, along the Y-axis of FIG. 4. Therefore, in the adjustment process, it is preferable to adjust the position of the gypsum slurry extracting device 114 so that the rotation center O32 of the rotating plate 32 and the center O114 of the gypsum slurry extracting device 114 are located on a straight line parallel to the width direction of the board base paper sheet 41 conveyed on the board base paper sheet conveying path.

In the adjustment process, it is possible to automatically adjust the position of the gypsum slurry discharge port of the gypsum slurry extracting device 114 of the mixer 11 to a predetermined position according to the position of the board base paper sheet conveyed, for example, by a control device (not illustrated). In this case, the mixing and stirring apparatus 10 may be provided with a detection device for detecting the position of the end portion of the board base paper sheet in the width direction and the position of the gypsum slurry discharge port of the gypsum slurry extracting device 114. The mixing and stirring apparatus 10 may also be provided with a driving device such as a motor used when the position of the housing 111 or the like is moved by the mixer moving device 13. The control device, the detection device, and the driving device may be connected in a wired or wireless manner so as to transmit and receive control signals, detection information such as the position information of the widthwise end of the board base paper sheet, and the position information of the gypsum slurry discharge port.

For example, the optimal position of the gypsum slurry extracting device 114 may be recorded for each type to be manufactured in advance, and the position of the gypsum slurry extracting device 114 may be adjusted according to the type to be manufactured. In this case, the position may be stored in a storage device, and the control device may be configured to adjust the position of the gypsum slurry extracting device 114 according to the input type to be manufactured.

The adjustment process can be carried out at any timing and can be carried out when the type of gypsum board to be manufactured is changed.

### (Molding Process, Curing Process, Drying Process, Cutting Process, and Carrying Out Process)

The method for manufacturing a gypsum board according to the present embodiment can also include, for example, a molding process, a curing process, a drying process, a cutting process, and a carrying out process.

In the molding process, the board base paper sheet and the gypsum slurry supplied on the board base paper sheet can be molded to form a molded body having a desired shape.

In the curing process, the gypsum slurry can be hydration-cured in the process of conveying the molded body.

The curing process can be carried out by condensing and solidifying calcined gypsum (hemihydrate gypsum) in the gypsum slurry with needle-like crystals of dihydrate gypsum formed by the hydration reaction. Therefore, in the molded body formed in the molding process, a reaction occurs between the water and the calcined gypsum contained in the gypsum slurry, and the hydration reaction of the calcined gypsum proceeds, so that the curing process can be carried out.

In the drying process, the excess moisture contained in the gypsum slurry can be dried by a drying device or the like. In the drying process, a molded body for which the curing process has been completed can be supplied. In the drying process, it is preferable to forcibly dry the molded body by using a drying device.

Although the method of forcibly drying the molded body by the drying device is not particularly limited, for example, a drying device can be provided on the conveying path of the molded body, and the molded body can be continuously dried by passing through the drying device. Further, the molded body can be carried into the drying device, and the molded body can be dried in batches.

In the cutting process, the obtained molded body can be cut to obtain a desired shape and size.

The method for manufacturing the gypsum board according to the present embodiment may include, for example, a first cutting step and a second cutting step as cutting steps.

In the first cutting step, for example, after the molding step, the molded body formed in the molding step can be roughly cut by a rough cutting cutter during the progress of the curing step or after the curing step is completed. In the first cutting step, the continuous molded body formed in the molding step can be cut to a predetermined length by a rough cutting cutter.

In the second cutting step, for example, after drying the molded body in the drying step, the molded body can be cut into a product of a predetermined length.

In the carrying out step, the obtained gypsum board can be stacked by a lifter or the like and loaded into a truck or the like for storage in a warehouse or for shipment.

Although the gypsum board has been described here as an example, various gypsum-based building materials can also be manufactured by changing the board base paper sheet that is the surface material to a glass fiber nonwoven fabric (glass tissue) or a glass mat, and arranging the material to be embedded on or near the surface.

Although the mixing and stirring apparatus, the gypsum board manufacturing apparatus, and the method for manufacturing the gypsum board have been described in embodiments, etc., the present invention is not limited to the above embodiments, etc. Various variations and changes can be made within the scope of the gist of the present invention described in the claims.

The present international application is based upon and claims priority to Japanese Patent Application No. 2022-028259 filed on Feb. 25, 2022, the entire contents of which are incorporated herein by reference.

### EXPLANATION OF REFERENCE NUMERALS

10 mixing and stirring apparatus
11 mixer
111 housing
111A upper plate
111B side plate
111C lower plate
112 rotary shaft
113 motor
114 gypsum slurry extracting device
115 raw material supply pipe
116 raw material hopper
117, 118 dispensing port
12 cradle
12A surface
13 mixer moving device
131 wheel
132 guide
A double-headed arrow
31 annular base
32 rotating plate
32A outer periphery
O32 rotation center
33 scraper
R arrow
40 gypsum board manufacturing apparatus
41 board base paper sheet (surface cover base paper sheet)
CL center line
W41 width
B block arrow
421 first board base paper sheet conveying path
422 second board base paper sheet conveying path
L1, L2, L3 line
A1 center region
D1, D2 distance
51 board base paper sheet (back cover base paper sheet)
521, 522 delivery pipe
53 first gypsum slurry
54 second gypsum slurry
55 roll coater
551 coating roll
552 receiving roll
553 foreign matter removing roll
56 turning roll
57 molding device

1. A mixing and stirring apparatus comprising:
a mixer configured to prepare a gypsum slurry; and
a mixer moving device, wherein
the mixer includes:
a housing;
a rotating plate arranged inside the housing;
a rotary shaft connected to the rotating plate;
a motor connected to the rotary shaft and configured to rotate the rotating plate; and
a gypsum slurry extracting device configured to discharge the gypsum slurry prepared in the housing, wherein
the mixer moving device is configured to move at least the housing, the rotating plate, the rotary shaft, and the gypsum slurry extracting device.

2. The mixing and stirring apparatus according to claim 1, wherein the rotary shaft is inserted into the housing from below the housing to be connected to the rotating plate.

3. The mixing and stirring apparatus according to claim 1, wherein
the motor is arranged below the housing; and
the mixer moving device is configured to also move the motor.

4. A gypsum board manufacturing apparatus comprising:
the mixing and stirring apparatus according to claim 1.

5. The gypsum board manufacturing apparatus according to claim 4, further comprising:
a base paper sheet conveying path configured to convey a base paper sheet, wherein
at least a part of the base paper sheet conveying path is located below the housing of the mixer or below the gypsum slurry extracting device included in the mixer.

6. A gypsum board manufacturing method comprising:
preparing the gypsum slurry by the mixer included in the mixing and stirring apparatus according to claim 1; and
supplying the gypsum slurry from the gypsum slurry extracting device included in the mixer onto a base paper sheet being conveyed.

7. The gypsum board manufacturing method according to claim 6, further comprising:
adjusting a position of the gypsum slurry extracting device according to a position of the base paper sheet.
